(19) United States
(12) Patent Application Publication
(10) Pub. No.: US 2026/0348790 A1
(43) Pub. Date: Nov. 5, 2026

(54) DEVICE FOR PREDICTING WEAR IN A HOSE AND METHOD THEREOF

(71) Applicant: THEJO ENGINEERING LIMITED, Chennai (IN)

(72) Inventors: Vijay U, Chennai (IN); Manoj JOSEPH K, Chennai (IN)

(21) Appl. No.: 19/101,907

(22) PCT Filed: Sep. 11, 2023
(86) PCT No.: PCT/IN2023/050855

§ 371 Date: Feb. 7, 2025

(30) Foreign Application Priority Data
Sep. 16, 2022 (IN) 202241053072

(51) Int. Cl. G01M 3/38; G01D 5/353

(52) U.S. Cl. CPC G01M 3/38; G01D 5/35354

(57) ABSTRACT

Provided is a slurry conveying hose (100) including a base layer (203) that forms the innermost layer of the hose (100) and an optical fiber cable (OFC) (102) wrapped around the base layer (203) extending throughout the length of the hose (100). The optical cable (102) configured to detect puncture from an inner diameter (ID) to the outer diameter (OD) of the hose (100) by using an optical time domain reflectometer (OTDR) (302).

### FIELD OF THE INVENTION

The present embodiment relates to slurry or fluid conveying hoses/pipes and more particularly relates to a device and method for predicting wear in the hose and evaluating residual wear life of the hose.

### BACKGROUND OF THE INVENTION

Fluid conveying hoses and pipes are widely used for transporting fluid such as oil, gas, water and fuel from one place to another. Usually, the fluid conveying distances are larger (in Kms) and consequently requires a fluid conveying hose of longer lengths. A different kind of hose for slurry conveying hoses are used to deliver abrasive slurry as a slurry handling process in mining industries.

Slurry handling in mining industries requires the abrasive slurry to be pumped through the rubber hoses and consequently may lead to wear and tear or leakage of the slurry conveying hoses. The leaks or punctures in the hoses, if not taken care of timely, may cause major breakdown in slurry handling process in mining industries. Such breakdowns may delay the mining processes and thus it becomes a need to predict the leaks of the hoses timely for replacing defected hose portions.

It becomes difficult to predict wear in slurry hoses by using conventional facilities known in the art due to highly restricted site conditions. The prior-art solutions for hose inspection require frequent stoppages across the length of the hose and are not able to identify the location of leak formed inside the slurry hose. Further, the prior art solutions are limited in examining complete cross-sectional dimensions of the hose which is a vital parameter while predicting punctures in hoses as the leak propagates from the inner side of the hose to the outside of the hose during slurry flow from the hoses. The prior art solutions do not propose examining of complete cross-sectional dimensions for predicting wear. Further, the methods and apparatus of the prior art require various components involved in the predicting punctures in pipes that makes the pipeline inspection systems unnecessarily complex.

This arises a need for providing a device or method of accurately predicting puncture locations in the slurry conveying hoses by use of simple arrangements.

### SUMMARY OF THE INVENTION

In view of the foregoing, an embodiment herein provides a slurry conveying hose (100) that includes a base layer (203) forming the innermost layer of the hose (100), an optical fiber cable (OFC) (102) wrapped around the base layer (203) extending throughout the length of the hose (100). The optical fiber cable (102) is configured to admit an optical light to determine wear or puncture from an inner diameter (ID) to the outer diameter (OD) of the hose (100) by using an optical time domain reflectometer (OTDR) (302).

In an embodiment, the OTDR (302) detects leaks from the inner diameter to the outer diameter of the hose (100) by using visual fault locating (VFL).

In an embodiment, the OTDR (302) detects leaks from the inner diameter (ID) to the outer diameter (OD) of the hose (100) by using fiber link mapping (FLM).

In an embodiment, the optical fiber cable (102) is configured detect leaks at one or more than one co-ordinates of the hose (100).

In an embodiment, the optical fiber cable (102) is spatially positioned between the inner diameter (ID) and the outer diameter (OD) of the hose (100).

In an aspect, a method for predicting wear in a slurry conveying hose (100) includes wrapping (202) a base layer (203) on a rod (201) of a hose making machine extending throughout the length of the hose (100), winding (204) an optical fiber cable (102) on the wrapped base layer (203) up to the length of the hose (100) and detecting wear from an inner diameter (ID) to an outer diameter (OD) of the hose (100) by using an OTDR (302).

In an embodiment, the OTDR (302) detects leaks from the inner diameter (ID) to the outer diameter (OD) of the hose (100) by using visual fault locating (VFL) method.

In an embodiment, the OTDR (302) detects leaks from the inner diameter (ID) to the outer diameter (OD) of the hose (100) by using fiber link mapping (FLM) method.

In an embodiment, the optical fiber cable (102) is configured to detect leaks at one or more than one co-ordinates of the hose (100).

In an embodiment, the optical fiber cable (102) is spatially positioned between the inner diameter (ID) and the outer diameter (OD) of the hose (100).

In an aspect a wear prediction system (500) including a slurry conveying hose (100) having a base layer (203), an optical fiber cable (102) wrapped around the base layer (203) of the hose (100). An optical time domain reflectometer (OTDR) (302) is operatively coupled with the optical fiber cable for introducing a visible light through the optical fiber cable (102) and the visible light inside the optical fiber cable (102) is configured to detect co-ordinates of break-point from an inside diameter to an outside diameter of the hose (100).

In an embodiment, the OTDR (302) further comprising a display screen (305) for showing wear data pertaining to the leakage or wear of the hose (100).

In an embodiment, the OTDR (302) further comprising an optical light source (303) for generating the visible light.

### BRIEF DESCRIPTION OF DRAWINGS

The above and still further features and advantages of embodiments of the present invention becomes apparent upon consideration of the following detailed description of embodiments thereof, especially when taken in conjunction with the accompanying drawings, and wherein:

FIGS. 1A and 1B depicts a slurry conveying hose incorporating an optical fiber cable, according to an embodiment herein;

FIGS. 2A, 2B, 2C and 2D illustrates a method of manufacturing the slurry conveying hose, according to an embodiment herein;

FIG. 3 illustrates an apparatus for testing the optical fiber cable, according to an embodiment herein;

FIG. 4A and FIG. 4B illustrates an apparatus for testing the slurry conveying hose, according to an embodiment herein; and

FIG. 5 illustrates a wear prediction system, according to an embodiment herein.

To facilitate understanding, like reference numerals have been used, where possible, to designate like elements common to the figures.

### DETAILED DESCRIPTION OF THE DRAWINGS

Various embodiment of the present invention provides a slurry conveying hose including an optical fiber cable for wear prediction and residual life evaluation of the hose. The following description provides specific details of certain embodiments of the invention illustrated in the drawings to provide a thorough understanding of those embodiments. It should be recognized, however, that the present invention can be reflected in additional embodiments and the invention may be practiced without some of the details in the following description.

The various embodiments including the example embodiments are now described more fully with reference to the accompanying drawings, in which the various embodiments of the invention are shown. The invention may, however, be embodied in different forms and should not be construed as limited to the embodiments set forth herein. Rather, these embodiments are provided so that this disclosure is thorough and complete, and fully conveys the scope of the invention to those skilled in the art. In the drawings, the sizes of components may be exaggerated for clarity.

It is understood that when an element or layer is referred to as being “on,” “connected to,” or “coupled to” another element or layer, it can be directly on, connected to, or coupled to the other element or layer or intervening elements or layers that may be present. As used herein, the term “and/or” includes any and all combinations of one or more of the associated listed items.

Spatially relative terms, such as “top,” “bottom,” and the like, may be used herein for ease of description to describe one element or feature's relationship to another element(s) or feature(s) as illustrated in the figures. It is to be understood that the spatially relative terms are intended to encompass different orientations of the structure in use or operation in addition to the orientation depicted in the figures.

The terms like punctures/leaks/wear/break-points are interchangeably used herein the description.

Embodiments described herein refer to plan views and/or cross-sectional views by way of ideal schematic views. Accordingly, the views may be modified depending on simplistic assembling or manufacturing technologies and/or tolerances. Therefore, example embodiments are not limited to those shown in the views but include modifications in configurations formed on basis of assembling process. Therefore, regions exemplified in the figures have schematic properties and shapes of regions shown in the figures exemplify specific shapes or regions of elements, and do not limit the various embodiments including the example embodiments.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, the various embodiments including the example embodiments relate to slurry conveying hose and wear prediction system for predicting wear in the slurry conveying hose.

As discussed, there remains a need for accurate prediction of punctures in the slurry conveying hose, the present embodiment relates to a slurry conveying hose provided with an optical fiber cable that facilitates prediction of wear, punctures or leaks in the hose.

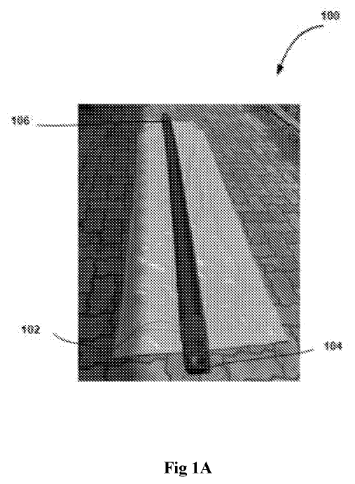

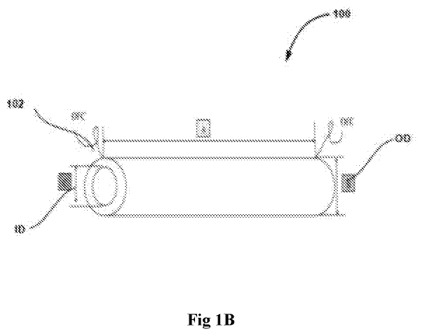

FIGS. 1A and 1B illustrates a slurry conveying hose (100) (hereinafter interchangeably used as “hose (100)”). The slurry conveying hose (100) includes an inner diameter (ID), an outer diameter (OD), an optical fiber cable (OFC) (102), a first end (104), a second end (106).

The optical cable (102) is embedded in the slurry conveying hose (100) throughout the length of the hose (100) that is all the way from the first end (104) to the second end (106) of the hose. The optical cable (102) is embedded such that the spatial position of the optical cable (102) lies between the inner diameter (ID) and the outer diameter (OD) of the hose (100), when seen from cross-section of the hose (100). The optical fiber cable (102) (hereinafter referred to as “OFC” or optical cable) includes multiple regions that are multi-detection nodes.

The abrasive slurry is pumped through either of the first end (104) or the second end (106) of the hose (100) when the hose (100) is deployed in industries such as mining industry, which causes wear, leaks or punctures in the hose (100). These punctures may be produced at specific locations across the length of the hose (100). The optical cable (102) of the hose (100) is configured to detect or inspect various leaks or punctures that may be produced while the slurry being pumped through the hose (100) and also facilitates in evaluation of residual wear life of the hose (100). The evaluation of the residual wear life of the hose (100) indicates the replacement time for the hose (100) and preventive measures can be taken accordingly. The optical cable (102) transmits an optical data from the inner diameter (ID) to the outer diameter (OD) of the hose (100), thereby detecting leaks from the inner diameter (ID) to the outer diameter (OD) of the hose (100). The leaks or punctures at various locations or points on the hose (100) can be detected that facilitates determination of the exact locations of the leaks across the length of the hose (100).

In an embodiment, the optical cable (102) used in the hose (100) is a single mode optical cable.

In an embodiment, the optical cable (102) used in the hose (100) is a multi-mode optical cable.

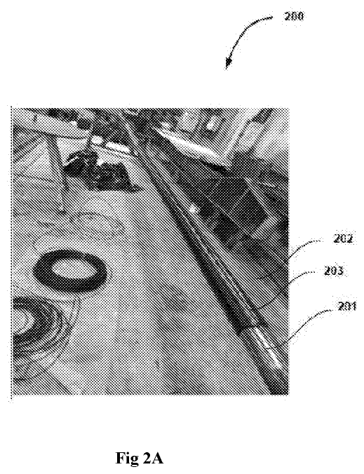

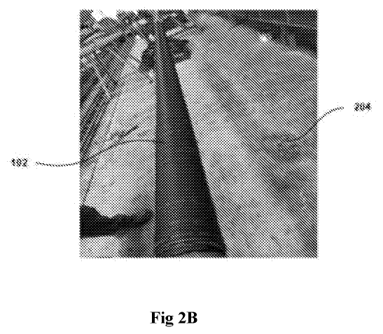

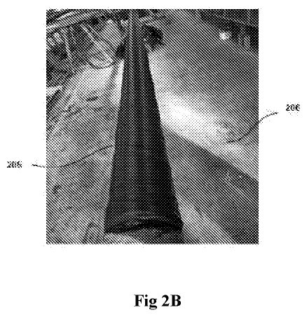

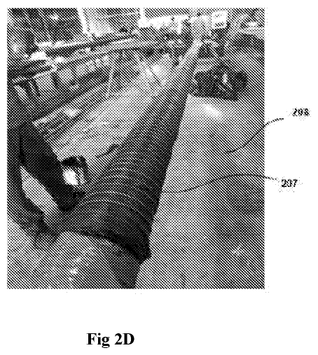

FIG. 2A-2D illustrates a method (200) of manufacturing the hose (100). The exemplary method of preparation involves spiral wrapping and method steps of which are as follows:
Wrapping (202), a base layer (203) on a rod (201) of a hose making machine. The base layer (203) is wrapped in a spiral fashion up to the length of the hose (100).
Winding (204), the optical cable (102) on the wrapped base layer (203) in a spiral fashion up to the length of the hose (100).
Wrapping (206), a tie gum layer (205) on the wound optical cable (102) in a spiral fashion up to the length of the hose (100).
Winding (208), a spring wire (207) on the wrapped tie gum layer (205) in a spiral fashion up to the length of the hose (100).

The base layer (203) is the innermost layer of the hose (100) that is configured as fluid impermeable layer, which refrains the fluid/slurry flowing in the hose (100) to leak.

In an embodiment, a carcass layer (not shown) can be wrapped just above the base layer (203) to provide reinforcement to the hose (100) and help the hose (100) to retain the original shape by preventing distortion in the hose (100) while conveying slurry.

In an embodiment, the carcass layer is applied by braiding, knitting, spiralling, wrapping or weaving processes on the hose (100).

In an embodiment, the hose (100) is provided with an outer sheath (not shown) that act as a protective covering for the hose (100). The outer sheath is configured to provide hose protection from external damage and environmental deterioration, such as from the ozone.

In an embodiment, a few more layers such as fabric layer and a UV-resistant layer are wrapped one on the top of the other while manufacturing the hose (100).

In an embodiment, the thickness of the base layer (203) is kept as 4.0 mm.

In an embodiment, the thickness of the optical cable (102) lies in a range between 1 milli-meter (1 mm) to 10 mm. Preferably, the thickness of the optical cable (102) is kept as 1.9 mm

In an embodiment, the thickness of the tie gum layer (205) is kept as 1.0 mm.

In an embodiment, the spring wire (207) is made up of steel having thickness of 3.0 mm.

In an embodiment, other hose manufacturing methods can be used, based on the size or cross-sectional dimensions of the hose (100). Examples of such method include but not limited to extrusion, spiral wrapping, calendaring, hand layup and molding etc.

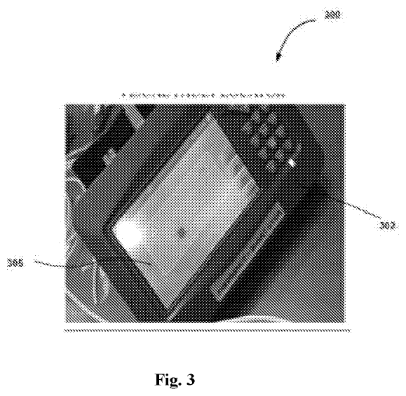

FIG. 3 illustrates an apparatus (300) for testing the optical fiber cable (102). The apparatus (300) includes an optical time domain reflectometer (OTDR) (302). The OTDR (302) uses a visual fault locating (VFL) or visual fault identifier (VFI) method and fiber link mapping (FLM) method for testing the optical cable (102).

The OTDR (302) enables testing of the optical cable (102) by transmitting and analyzing a laser light or visible light into the optical cable (102). The OTDR (302) uses the information obtained from the resultant light signature reflected or scattered back to the point, from where the laser light is transmitted inside the optical cable (102), thus the OTDR (302) acts as an optical radar system, providing the user with detailed information of the co-ordinates of wear and overall condition of splices, connections, defects and other interested features related to the optical cable (102).

While implementing the (VFL) method for detecting any fault in the optical fiber cable (102), a laser light or visible light having wavelength of about 360 to 670 nm is introduced into the optical fiber cable (102) for detection of sharp bends or break-points in the optical fiber cable (102). The injected visible light travels along the core until it reaches a fault or break-point, from where it gets leaked out. This leaked light from the location of the wear or break-point can be seen through a plastic coating and jackets covering the optical cable (102) under a suitable illumination. The co-ordinates of the break point, if any formed on the optical cable (102) can be detected. Therefore, the (VFL) method is capable of measuring continuity of the optical cable (102) in the slurry conveying hose (100).

While implementing the (FLM) method for detecting any fault in the optical fiber cable (102), the (FLM) method measures the complete trace of the optical fiber cable (102) i.e., the (FLM) method enables to identify any splicing, break-point, bending, crack, connector in the hose (100).

Either of the methods (VFL) and (FLM) as mentioned above does not require any signal booster or modulator for injecting laser light through the optical cable (102) to determine leaks or punctures in the hose (100), which eliminates any complexities involved in the leak detection for the hose (100).

In an embodiment, the OTDR (302) further includes a display screen (305) for depicting the wear related data for optical fiber cable (102).

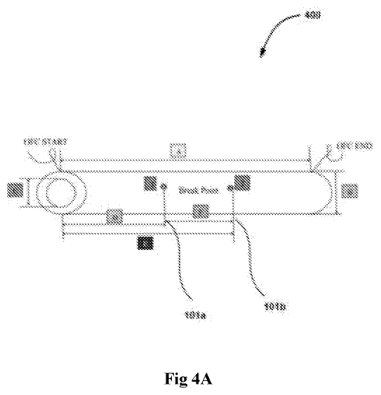

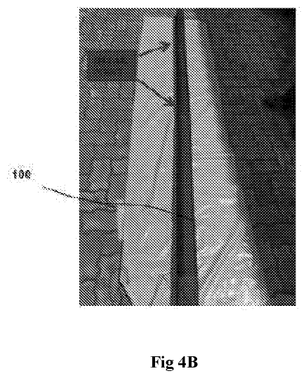

FIGS. 4A and 4B illustrates an apparatus (400) for testing the hose (100). The apparatus (400) uses the OTDR (302) for performing test on the hose (100) in order to detect any leaks/punctures/break points etc. inside the hose (100). The apparatus (400) perform testing on the entire length of the hose (100). The test on the hose (100) is executed by way of intentionally making manual break-points at certain distances along the length of the hose (100). These break-points are then detected by using the OTDR (302) by implementing the (FLM) method as discussed above. Further, to cross-check the position of the manually formed break-points on the hose are compared with the leak detection data provided by the OTDR (302), which ensures proper testing of the hose (100).

In an embodiment, the OTDR (302) further includes a display screen (305) for depicting the wear related data for the slurry conveying hose (100).

In an exemplary embodiment, two break points (101a, 101b) out of which the first break point (101a) is made at the distance of 1232 mm from one end of the hose (100) and the second break point (101b) is made at the distance of 828 mm from the first break point (101a) on the hose (100) having a length of 3040 mm. The optical cable (102) is wrapped around the hose by forming 620 number of turns on the hose (100). The first break point (101a) is detected at 251.42^{th} turn of the optical cable (102) and the second break point (101b) is detected at the 420.40^{th} turn of the optical cable (102). The first break point (101a) and the second break point (101b) are detected by implementing the (VFL) and (FLM) methods by using the OTDR (302). The lagging distance between the number of turns of the optical cable (102) is hardly 20 mm that is very less and there is no scope of missing any crack point while prediction of wear in the hose (100).

In an embodiment, lagging distance and pitch distance between the number of turns of the optical cable (102) is continuous or less than 20 mm.

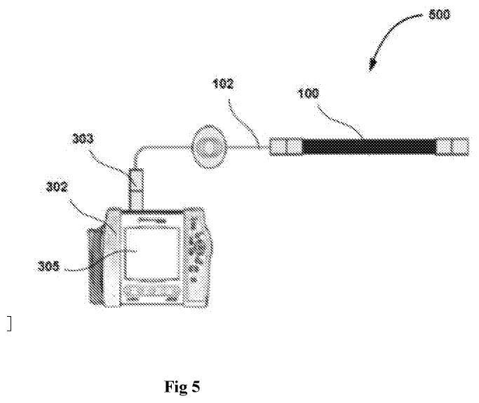

FIG. 5 illustrates a wear prediction system (500). The wear prediction system (500) is configured to predict wear in the slurry conveying hose (100). The wear prediction system (500) includes an OTDR (302), a slurry conveying hose (100) and an optical fiber cable (102). The OTDR (302) further includes a light source or LED (303) for producing an optical light or visible light. The optical fiber cable (102) is wrapped around a base layer (203) of the hose (100). The OTDR (302) is operatively coupled with the optical fiber cable (102) for transmitting the visible light produced by the light source (303). The visible light is configured to detect the co-ordinates of break-points of the optical cable (102) by using the VFL method and the FLM method as discuss above.

In an embodiment, the OTDR (302) further includes a display screen (305) for depicting the wear related data for the slurry conveying hose (100).

Certain advantages of the present disclosure are listed hereinbelow:—
The optical time domain reflectometer (OTDR) (302) is capable of measuring continuity of the optical cable (102) in the slurry conveying hose (100) by using visual fault locating (VFL) method.
The optical time domain reflectometer (OTDR) (302) by using the FLM method is capable of measuring the complete trace of the optical fiber cable (102) i.e., to identify any splicing, break-point, bending, crack, connector in the hose (100).

The foregoing discussion of the present disclosure has been presented for purposes of illustration and description. It is not intended to limit the present invention to the form or forms disclosed herein. In the foregoing Detailed Description, for example, various features of the present invention are grouped together in one or more embodiments, configurations, or aspects for the purpose of streamlining the disclosure. The features of the embodiments, configurations, or aspects may be combined in alternate embodiments, configurations, or aspects other than those discussed above. This method of disclosure is not to be interpreted as reflecting an intention the present invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate embodiment of the present invention.

Moreover, though the description of the present disclosure has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

We claim:

1. A slurry conveying hose (100) comprising;
a base layer (203) forming the innermost layer of the hose (100);
an optical fiber cable (OFC) (102) wrapped around the base layer (203) extending throughout the length of the hose (100); wherein the optical fiber cable (102) is configured to admit an optical light to determine wear or puncture from an inner diameter (ID) to the outer diameter (OD) of the hose (100) by using an optical time domain reflectometer (OTDR) (302).

2. The slurry conveying hose (100) as claimed in claim 1, wherein the OTDR (302) detects leaks from the inner diameter to the outer diameter of the hose (100) by using visual fault locating (VFL).

3. The slurry conveying hose (100) as claimed in claim 1, wherein the OTDR (302) detects leaks from the inner diameter (ID) to the outer diameter (OD) of the hose (100) by using fiber link mapping (FLM).

4. The slurry conveying hose (100) as claimed in claim 1, wherein the optical fiber cable (102) is configured detect leaks at one or more than one co-ordinates of the hose (100).

5. The slurry conveying hose (100) as claimed in claim 1, wherein the optical fiber cable (102) is spatially positioned between the inner diameter (ID) and the outer diameter (OD) of the hose (100).

6. A method for predicting wear in a slurry conveying hose (100) comprising;
wrapping (202) a base layer (203) on a rod (201) of a hose making machine extending throughout the length of the hose (100);
winding (204) an optical fiber cable (102) on the wrapped base layer (203) up to the length of the hose (100);
detecting wear from an inner diameter (ID) to an outer diameter (OD) of the hose (100) by using an OTDR (302).

7. The method as claimed in claim 6, wherein the OTDR (302) detects leaks from the inner diameter (ID) to the outer diameter (OD) of the hose (100) by using visual fault locating (VFL) method.

8. The method as claimed in claim 6, wherein the OTDR (302) detects leaks from the inner diameter (ID) to the outer diameter (OD) of the hose (100) by using fiber link mapping (FLM) method.

9. The method as claimed in claim 6, wherein the optical fiber cable (102) is configured to detect leaks at one or more than one co-ordinates of the hose (100).

10. The method as claimed in claim 6, wherein the optical fiber cable (102) is spatially positioned between the inner diameter (ID) and the outer diameter (OD) of the hose (100).

11. A wear prediction system (500) comprising; a slurry conveying hose (100) having a base layer (203);
an optical fiber cable (102) wrapped around the base layer (203) of the hose (100);
an optical time domain reflectometer (OTDR) (302) is operatively coupled with the optical fiber cable for introducing a visible light through the optical fiber cable (102); wherein
the visible light inside the optical fiber cable (102) is configured to detect co-ordinates of breakpoint from an inside diameter to an outside diameter of the hose (100).

12. The wear prediction system (500) as claimed in claim 11, wherein the OTDR (302) further comprising a display screen (305) for showing wear data pertaining to the leakage or wear of the hose (100).

13. The wear prediction system (500) as claimed in claim 11, wherein the OTDR (302) further comprising an optical light source (303) for generating the visible light.
